(19) United States
(12) Patent Application Publication
(10) Pub. No.: US 2015/0074825 A1
(43) Pub. Date: Mar. 12, 2015

(54) SYSTEM AND METHOD FOR CONTROLLING PRIVACY SETTINGS OF USER INTERFACE WITH INTERNET APPLICATIONS

(71) Applicants: Jonathan Blake, Vancouver (CA); Clayton Gunars Strauts, Vancouver (CA)

(72) Inventors: Jonathan Blake, Vancouver (CA); Clayton Gunars Strauts, Vancouver (CA)

(21) Appl. No.: 14/395,800

(22) PCT Filed: Apr. 19, 2013
(86) PCT No.: PCT/CA2013/050308

§ 371 Date: Oct. 20, 2014

Related U.S. Application Data
(60) Provisional application No. 61/636,502, filed on Apr. 20, 2012.

(51) Int. Cl. G06F 21/62

(52) U.S. Cl. CPC G06F 21/6245
USPC 726/28

(57) ABSTRACT

A system and method for controlling access to a user's account has a graphical user interface for displaying content on the user interface, a display window in the user interface for displaying content from at least one content source associated with the user's account, and a plurality of profile access modes selectable by the user for determining the scope of the user's access to the account, including a limited profile access mode for limiting the scope of user's access to the account and the content visible on the account. The system also has an identifier associated with the limited access mode. When the user attempts to access the account from a source associated with the identifier associated with the limited access mode, the user's account is accessible only through the limited profile access mode.

### 1. RELATED APPLICATIONS

The present application claims priority to previously filed U.S. Provisional Patent Application No. 61/636,502 filed on Apr. 20, 2012, the contents of which are hereby incorporated by reference in their entirety.

### 2. TECHNICAL FIELD

The present invention relates generally to systems and methods for providing user control of privacy settings for interface with internet applications and more particularly to systems and methods for providing a user login interface for controlling internet communication and social network content displayed and accessible from within a user's profile.

### 3. BACKGROUND OF THE INVENTION

People are increasingly using virtual products and services on their personal computing devices, such as using electronic mail (i.e. e-mail) and instant messaging, to communicate with one another. People are also using Internet based social networking, content sharing and dating tools to network and interact with others. People are also increasingly using virtual tools for entertainment and leisure activities, such as Internet based games, online movies, Internet music, social networking, virtual books and magazines, news, and sports score feeds. Moreover, people are increasingly using mobile computing devices, such as mobile phones, laptop computers, and tablets, to access and for use with these virtual products and services.

With the increasing popularity of using virtual products and services available on personal computing devices, many users have found a need to control and preserve user privacy, and through this desire to maintain one's privacy, anonymity, or to separate interaction with multiple different groups of people or spheres of interest, many people have developed multiple virtual personas for themselves, such as professional and personal personas. For example, many people use different email addresses or social networking accounts to separate their professional and personal communication. Many people also create separate professional and personal profiles on social networks to maintain privacy between their professional and personal lives and seek to maintain privacy boundaries between these different profiles. Some people even maintain multiple professional or multiple personal personas in order to preserve their personal privacy when interacting with different types of services or different groups of users.

However, with the increasing popularity of using virtual products, services, and social networking applications on personal computing devices and the perceived risks of virtual activities or content to outside perceptions, instances of third parties, such as employers, demanding that social network users disclose their usernames and passwords or divulge their online activities have become more common. For example, an increasing number of employers, such as corporations or government agencies, have begun to closely monitor their employees' personal computing activities in employees' personal blogs or social networking profiles even when such activities occur outside of the employment environment. Some employers have sought to gain access to employees' social networking profiles or other private online information to view or police user content or online activities. Specifically, some employers may even require employees to disclose the user authentication details and personal login identification associated with their personal social networking profiles, such as account identification information and passwords associated with the employees' personal e-mail or social networking accounts. Some employers have required that employees provide their social networking usernames and passwords as a condition of employment in order to enable the employer to log in as the user itself. For example, prospective employers have asked prospective employees for the usernames, passwords, and credentials associated with their social networking accounts on job applications or during the job interview process. As a result, more and more employees have become concerned with preserving the privacy of the content displayed and accessible from within their personal e-mail accounts and social networking profiles. Consequently, there is a need for social networking users to be able protect the privacy of their social networking profiles from the user perspective.

### 4. SUMMARY OF THE INVENTION

The present invention facilitates a social network user's ability to preserve the privacy of a social networking account or profile by providing a user login interface that has multiple privacy tiers for controlling the type of internet communication and social network content displayed and accessible from within the user's account or profile. Specifically, the present invention provides a system for preventing certain content from being displayed or accessible from within a user's social network or e-mail accounts.

For the purposes of the present application, a persona refers to one or more of a user's virtual personality, character, or role that allows the user to post and interact with online content anonymously or from a desired personality, character, or role. Examples of user personas include a professional persona, a personal persona, a family persona, an entertainment persona, a dating persona, or an anonymous persona. The personas may be associated with one user, who may create and manage multiple personas for different purposes.

For the purposes of the present application, a graphical user interface (GUI) refers to one or more of the interface components typically displayed on a display of an electronic or computing device that allow for interaction and manipulation by the a user and the data with which the user interacts. GUI interfaces may emulate a virtual desktop or mobile display environment, display graphics, and allow interaction between a user and virtual or online profiles or accounts through, for example, a display, screen, a touch screen, or other display or input device on a personal electronic or computing device.

For the purposes of the present application, an “icon” is a graphic image which may be displayed on a computer screen or other computing display device and usually corresponds in appearance to the type of information, system resource, or application which it provides access to when it is visible. It is a graphical object which represents and serves to identify information, system resources, applications, and the like, and may exist inside any particular window, including the virtual desktop itself. An icon may be associated with a particular collection of computer information, typically representing a “file” which may be a collection of data, a particular device or device handle, an application, program, and the like. An icon also may represent a window corresponding to, for example, an application in an active but “minimized” state.

A “file” generally refers to a collection of information or data which the user wishes to use, create or modify; each particular file has an associated unique name for identification by both the system and the user. Any given file may typically be located within the information management system by knowing a file name, an iconographic representation associated with the name, or a window name associated, for example, with a group of files which are stored together. All information (files) grouped within a particular window may be identified with that particular window's own identification location within the computer information management system. Accordingly, a user interface screen display, for example, may be broken down into multiple windows and graphic icons.

Another important element of some conventional user interfaces is a screen or display cursor. The cursor allows direct user control over the user interface and generally represents the point on the desktop or user interface which is presently “active”, e.g. where input may be received, or output may be seen or taken. A user interface may be complemented with a “mouse” , touch screen, or other suitable input or pointing device and a corresponding display “pointer” which makes up the cursor control device and provides a “point-and-click” or “point and select” user interface. The pointer may be used to change where on the desktop or GUI the active cursor is at a given time. A mouse or other pointing or input device may typically be an electromechanical device that translates two-dimensional (or three-dimensional) mouse movement or touch screen contact location controlled by a user into a two-dimensional (or three-dimensional) screen position movement represented by, for example, a pointer or arrowhead. The user may contact and direct the mouse or pointing device while observing the position of the pointer on the screen thus bringing the user and the computer closer together via the interaction between the user, the mouse or pointing device, the pointer and the display. When the mouse or pointing device is manipulated, signals are generated and input to the computer on an input port or connection and the pointer moves correspondingly to a point on the display. Visual feedback may be used to control the exact location of the pointer by movement of the mouse or pointing device. In addition, the computer may store the location of the pointer which corresponds to an exact location on the display. It should be noted that the computer may also store the location of each icon or other interactive object such that when the pointer and an icon location coincide, specific actions may be taken by the user to “activate” the icon as described in greater detail herein below. In other systems, such as those utilizing a touch screen display device, pointing functionality may be substituted by the user touching the screen in a desired location with their finger, or other suitable stylus or pointing device, for example.

In systems using a mouse, the mouse may also be provided with one or more buttons or push tabs which may be used to effectuate control over the pointer by selecting or deselecting specific icons or other interactive tools. The mouse may be considered to be “activated” when the mouse button or tab is depressed and the pointer remains active until the button or tab is released. Pointer activation may also be initiated by sequences of mouse button or tab presses, such as a “double click” interaction which involves rapidly pressing the mouse button or tab press twice in sequence. By placing the pointer in a new location on the desktop and “clicking” or “double clicking”, the location of the active cursor, for example, may be changed to a new window, or, for example, an application may be launched by “double clicking” on the application's icon. However, as the desktop or GUI becomes increasingly crowded with icons, open windows and other selection options problems may arise. Analogously, in touch screen systems, single or double touches of the screen may be used to activate user interface features, for example.

Toolbars offer easier and more direct access to key commands of an application by presenting these commands as tabs either as part of the application's primary task window or in a floating window. Toolbars are typically programmed by an application developer as part of an application program since the function associated with the toolbar selection is often closely tied to one or more functions performed by the application. Problems arise, however, in that if a configuration change is needed in the application requiring, for example, that new functions must be added to the application toolbar, a separate and complex human interface dedicated to the task of adding the new function is required. Often times, rebuilding of the application (e.g. compiling, linking, and the like) is needed to change the configuration of the toolbar. Moreover, as other, similar applications are used, a separate toolbar must be configured for each application and deliberately saved to preserve the new toolbar settings for the particular application.

The present invention is directed to a system for controlling access to a user's account. The system has a graphical user interface for displaying content on the user interface and integrating and manipulating content on the user's account, a display window disposed within the user interface for displaying content from at least one content source associated with the user's account, a plurality of profile access modes selectable by the user for determining the scope of the user's access to the account. The plurality of profile access modes has a limited profile access mode for limiting the scope of user's access to the account and the content visible on the account and an unlimited profile access mode for providing the user with unlimited access to the account and to the content visible on the account. The system also has an identifier associated with the limited access mode. When the user attempts to access the account from a source associated with the identifier associated with the limited access mode, the user's account is accessible only through the limited profile access mode. The privacy identifier may be a password, an IP address, a geographical location, a virtual location, or a type of device. The user's account may be a social network account, an e-mail account, or a profile. The system also has a privacy grid window for selecting one or more privacy tiers and for controlling privacy of the content accessible by the user when logged in under the limited profile access mode.

### 5. BRIEF DESCRIPTION OF THE DRAWINGS

A graphical user interface system for controlling the type of internet communication and social network content 19 displayed and accessible from within the user's account or profile according to several embodiments of the present invention is described with reference to the accompanying drawing figures, in which:

FIG. 1 illustrates a schematic diagram of a graphical user interface system for displaying content to a user interface and for integrating information and social network content management according to an embodiment of the present invention.

FIG. 2 illustrates a schematic of a process by which a system determines and controls the scope of a user's access to user profile information, according to an embodiment of the present invention.

FIG. 3 illustrates a front view of a graphical user interface for logging a user into a system in an unlimited access mode using an unlimited access password, according to an embodiment of the present invention.

FIG. 4 illustrates a front view of a graphical user interface system for displaying content to a user in an unlimited access mode according to an embodiment of the present invention.

FIG. 5 illustrates a front view of a graphical user interface window for posting content corresponding to when a user is logged into the system in an unlimited access mode, according to another embodiment of the present invention.

FIG. 6 illustrates a front view of a privacy grid window for selecting personas and privacy tiers for uploaded content, according to an embodiment of the present invention.

FIG. 7 illustrates a front view of a password customization interface window for adding and editing passwords associated with a user interface, according to an embodiment of the present invention.

FIG. 8 illustrates a front view of a password editing window of a graphical user interface for adding or editing information associated with a user password, according to an embodiment of the present invention.

FIG. 9 illustrates a front view of a graphical user interface for logging a user into a limited access mode using a limited access password, according to an embodiment of the present invention.

FIG. 10 illustrates a front view of a graphical user interface system for displaying content to a user in an unlimited access mode, according to an embodiment of the present invention.

### 6. DETAILED DESCRIPTION OF SEVERAL EMBODIMENTS

The present invention facilitates a social network user's ability to preserve the privacy of a social networking account or profile by providing a user login interface that has multiple privacy tiers for controlling the type of internet communication and social network content 19 displayed and accessible from within the user's account or profile. Specifically, the present invention provides a system for preventing certain content 19 from being displayed or accessible from within a user's social network or e-mail accounts.

Several embodiments of the present invention provide for graphical user interface systems for displaying content on a user and for integrating information, communication and social network content and user privacy and/or access management. Further embodiments also provide for methods of manipulating and controlling information, communication and social network content and accessibility of such content using a graphical user interface (GUI) system. The systems according to certain embodiments of the present invention may be used in one or more types of computing systems such as desktop, laptop, touch screen, mobile phone, tablet, e-reader, or other types of computer systems comprising a user interface.

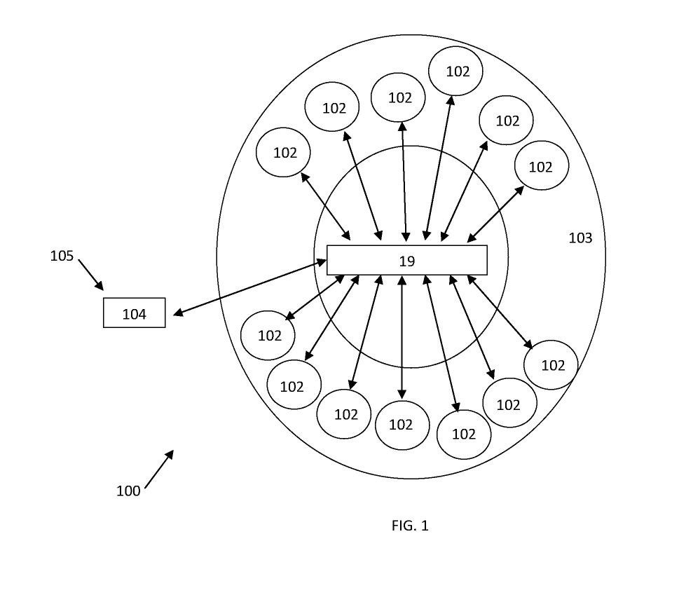

FIG. 1 illustrates a graphical user interface system 400 for displaying content 19 on a graphical user interface (GUI) 104 and for integrating information and social network content management according to an embodiment of the present invention. The user interface 104 may be in or on a user computing device 105 such as a mobile phone, laptop computer, desktop computer, touch screen computer or a tablet, for example. The system 400 interacts with several different virtual or online sources of content 102. These content sources 102 may be connected to one another through a network 103 which may include one or more of: a local area network, wide area network, world wide web (WWW), or the global Internet, for example, such that a computing device 105 may communicate with other computers including virtual sources of content 102 similarly connected to the network 103. The user interface 104 may be connected to this network 103 by any suitable means, such as wired, wireless or other network connections, for example, which allow for the transmission of data.

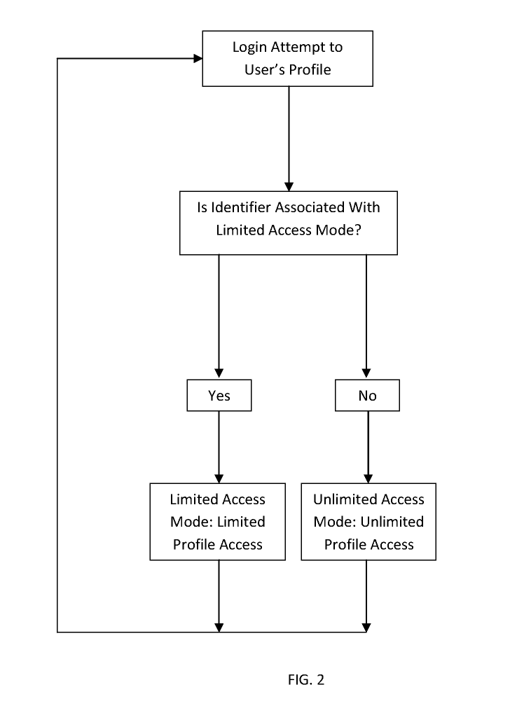

FIG. 2 illustrates a schematic view of a process associated with a graphical user interface system 400 showing how a user's access to a user profile may be limited based on certain identifying characteristics associated with the time, place, or manner of the user's login, in accordance with an embodiment of the present invention. In one such embodiment, the user may designate one or more certain identifiers, such a password, geographical coordinates of the user, IP address of the user's current device, or types of computing devices from which a login attempt is made, which the system may use to determine whether a user's access to the user profile should be limited. The system may determine whether to limit a user's access to the profile based on one or more of the identifier characteristics.

One way by which the scope of a user's access to an account profile may be limited is by using multiple passwords associated with the user's one profile. Each password may be associated with unique privacy settings. A user may create a limited access password specifically for use by a third party person or entity, such as an employer, that demands access to a user's personal profile, such as a personal social networking profile, for example.

In one embodiment, a user may customize the privacy settings associated with this limited access password. The privacy settings associated with this limited access password may be configured to filter out certain content and information from the display of the user's profile, such as political or religious content. In one embodiment, the privacy settings may filter and block this content from the reach or visibility of a user who logs into the profile using this limited password, or through a limited profile access mode. As a result, this user would only be able to access and view the limited profile, absent the political or religious content, which may be configured to be filtered out when the profile is accessed using the limited access password, for example.

In one example, if the user's employer demands that the user provide the employer with access information for the user's personal social networking account, and the user does not want to give the employer full access to the user's personal information, the user may create an employer password, customize the privacy settings associated with this employer password, assign filters to the employer password which prevent the employer from viewing certain personal content in the user's profile, prevent the employer from accessing or viewing this information, while avoiding jeopardizing the user's employment status which may occur if the user refuses the employer's demand for access to the user's account or profile.

In a further embodiment, other identifiers may also be associated with a limited profile access mode. Any known identifiers may be used to limit access to the user's profile based on the identifier characteristics. For example, the user may also associate a limited privacy setting with the geographical coordinates, IP address, or virtual location of the person or device attempting to log into the user's profile. For example, the user may associate the employer's physical or virtual location with limited profile access privacy settings such that any login attempt from the employer's location or computer system would only allow access to the user's profile on a limited basis. Likewise, the user may also restrict login attempts to the user's social network or other account profile from certain types computing systems or devices, such as mobile computing devices, to a limited access user mode.

FIG. 2 illustrates a schematic view of a process by which the system determines whether to permit access to a user in a limited or unlimited access mode, according to an embodiment of the invention. In such an embodiment, first, login access to the user's personal profile is attempted 51. One or more identifiers, such as a login password or physical location of the access source, or IP address or device type associated with the access source are communicated to the system. The system compares the one or more identifiers with the account or profile data stored in the system, and determines whether the identifiers are associated with a limited or unlimited profile access mode. If the system determines that the identifier is not associated with a limited access mode, the system permits access to the user's profile in a normal, unrestricted or unlimited mode. Alternatively, if the system determines that the identifier is associated with a limited access mode, the system permits only limited access to the user's profile. In the example of an employer accessing an employee's personal social networking or other account profile, a limited access mode may be permitted access to a limited amount of the employee's personal information or limited content 19 visible from within the employee user's profile.

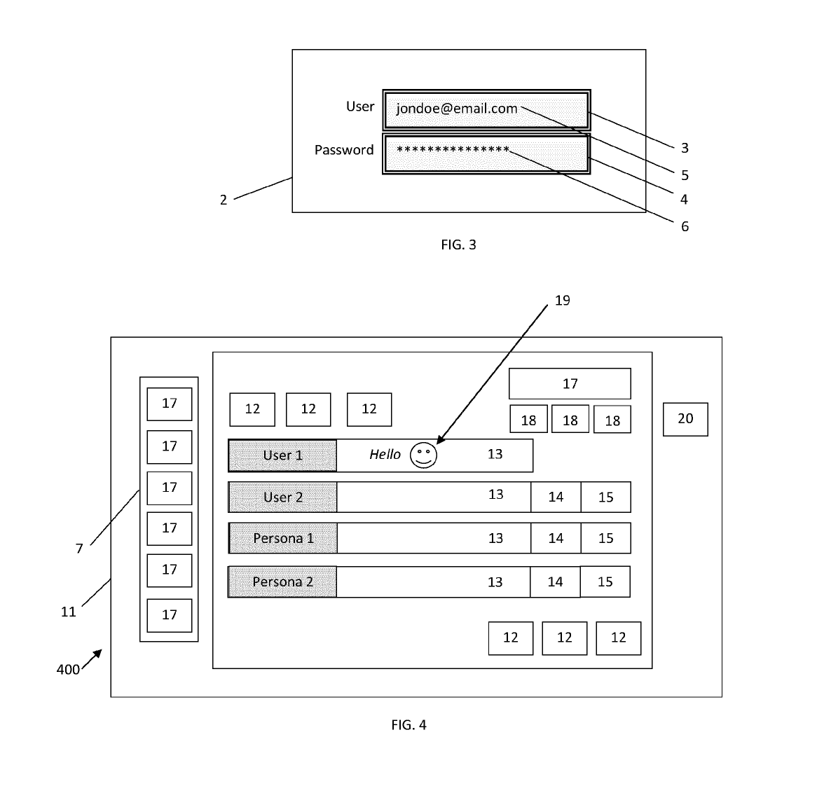

FIG. 3 illustrates a front view of a user login display window 2 of a graphical user interface, according to an embodiment of the present invention, where the user is logging into the user interface in a normal, unlimited mode using a user-defined, unlimited access password. An exemplary fifteen (15) character unlimited access password is illustrated in FIG. 3. The user login display window 2 contains text boxes 3, 4 for inputting a username 5 and an access password 6 into the system.

FIG. 4 illustrates a front view of a main display window 11 of a graphical user interface system 400 according to an embodiment of the present invention, where the user interface is displayed in an unlimited access mode. In this mode, all content 19 posted on or accessible to the user's profile is visible to the user on the display window 11. No content 19 is filtered out or restricted from the user's view. The system 400 has a main display window 11 for displaying or interacting with user content 19 from at least one source, such as a social network and in one embodiment may also have a vertical panel 7 for displaying or interacting with content 19 from at least one source, such as a social network or other user content account and/or customizing user profile settings.

As illustrated in FIG. 4, in one embodiment the main display window 11 has a vertical panel 7 for displaying chronologically updated content 19 from at least one social network or other user content account, managing account settings, obtaining technical support, or manipulating and interacting with the content 19 on the user interface. The content 19 may include, for example, information from an email account, an online banking account, a social network account(s), a news feed, a blog feed, a user forum, a user content sharing feed, a chat forum, an instant message system, a messaging stream or feed, a music account, an audio/visual media account, a social network account, or an Internet-based search engine, for example. The account settings may be, for example, managing password settings, privacy settings, and/or multiple personas associated with the user's account.

In some embodiments, the vertical panel 7 may have frames 17, content category selection tab(s) 17, account setting tabs 17, or windows 17 for displaying an image from one or more user content accounts, social networks or feed(s), and/or for manipulating and interacting with the content 19 on the user interface. In some embodiments, one or more frame or window may have a drop-down selection box that has information about the image from the account(s) or feed(s). The tabs 17 disposed on the vertical panel 7 may be, for example, a content category selection tab to select the type(s) of content 19 to be chronologically displayed on the vertical panel 7, and windows for displaying an image and/or information from at least one social network or user content account or feed, such as one or more email account, online banking account, news feed, chat forum, instant message system, music account, audio/visual media account, social network account, online dating accounts or Internet-based search engine, a tab for editing user account settings, and/or obtaining help or support, for example. Each frame or tab 17 may optionally have a drop-down box that contains information about the image or information from at least one user account or feed.

The vertical panel 7 may also optionally be moveable within the user interface separately from the main display window 11. The vertical panel 7 may also optionally be opaque or translucent, and may typically be disposed in front of the rest of the content 19 on the user interface for visibility and accessibility. In some embodiments, the vertical panel 7 may also fade into and out of view on the interface such as depending on which other windows the user may select or have active on the GUI.

The main display window 11 may be a screen on a mobile phone, laptop or desktop computer, or a tablet, and may have one or more of main window tab(s) such as for opening, minimizing and closing the window, drop down menu(s), and a scrolling feature such as a scrollbar for moving the content 19 within the main display window 11 of the user interface and displaying content 19 from at least one social network and/or other user content 19 account or internet content source. In one embodiment, the display window may also have one or more content interaction tabs 12 for interacting with the content 19 on the main display window 11, and may optionally also have a micro-comment tab 14 for uploading comments about the comments displayed on the window 11, an approval tab 15 for approving micro-comments, text boxes 13 for entering text onto the display window 13, a text box 17 for searching through and filtering posts, filter tabs 18 for filtering news feed by content 19 type, and a new post tab 20 for opening a content posting window 21 through which new posts and additional content 19 may be added to the display.

In one such embodiment, the micro-comment tab 14 may be used for uploading comments about the comments already displayed in the social network or other content 19 shown in main display window 11. The user may also make micro-comments, or comments related to other posted comments or uploaded media, on the display window using the micro-comment button. The micro-comment button 14 may have, for example, a micro-comment text box for entering secondary micro-comments about the content 19 displayed in the display window, a micro-comment select user-persona button for selecting user-persona(s) associated with the micro-comments, and a micro-comment post button for uploading and displaying the micro-comments in the main display window 11. In one embodiment, to post a micro-comment, the user selects a micro-comment button 14 on the display window. A micro-comment window 21 appears and has at least one text box and a plurality of buttons for entering and manipulating micro-comment content 19 and information. The user may then enter the micro-comment information, such as text, images, geographical location information, or category tags, into the comment text box 22. The user then posts the micro-comment by selecting the save tab 25.

In a particular embodiment, the new post tab 20 may also be used for uploading content, such as text or media, into the social network and displaying the content on the main display window 11. Selection of the new post tab 20 may then open a content posting window 21 for uploading content 19, such as text comments or media, according to another embodiment of the present invention. FIG. 5 illustrates a content posting window 21 according to an embodiment of the invention. The content posting window 21 may have, for example, a text box 22 for entering text, content manipulation tab(s) 23 for manipulating the content 19, a cancel tab 24, a next or save tab 25 and text box(es) 27 for interacting with content 19 on the main display window 11, such as posting comments on a website, and uploading and/or downloading media to/from a social network or a user content 19 account. In one such embodiment, the tabs 23 for manipulating the content 19 are, for example, for associating a link, title, geographical location information, image, notification, person, story, or label to the content 19. After the user is finished uploading and manipulating content 19 in the post content 19 window 21, the user may then post the content 19 on the social network or main display window 11 such as by selecting a save tab 25. Alternatively, if the user does not wish to post the content 19, the use may select a cancel tab 24. In one such embodiment, this action of selecting the save tab 25 may trigger the appearance of the privacy selector interface to the user.

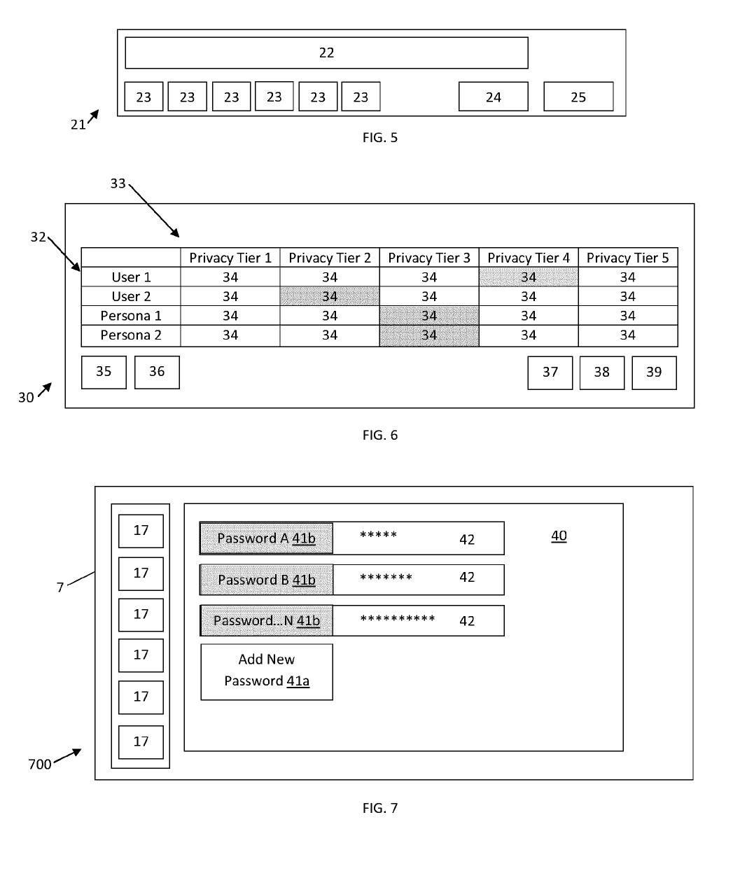

In one embodiment, after uploading the micro-comments text or media content and selecting the save tab 25, a privacy grid window 30, as illustrated in FIG. 6, appears for selecting a persona from which to upload/post the micro-comment and/or content 19 and assigning a privacy tier setting (e.g. Privacy Tier 1, Privacy Tier 2, etc.) to the content in order to prevent the content from being visible or accessible to a user logged into the profile in a limited access mode. As discussed above, the user may create multiple personas, such as a professional persona, personal, or anonymous persona associated with the user's profile, and associate all of them with the user's profile. In the privacy grid window 30, the user may select a persona from which to upload/post the comment and/or content 19. For example, the user may select a professional persona from which to upload content relating to the user's area of professional expertise or employment. In another example, the user may select a religious persona from which to upload content relating to the user's religion or religious activities. The user may assign privacy tier settings to this content in order to control which content is visible to other users within a social network or other user system and also to control which content is visible to other users logged into the user's profile in a limited access mode. For example, the user may assign a relatively heightened privacy tier to all content posted from the user's religious persona so that if the user's employer is logged into the user's profile in a limited access mode, the content posted by the user's religious persona will not be visible to this employer. In one embodiment, after the user uploads the content 19, selects the persona from which to upload the content, and sets the privacy settings associated with the content 19, the user may then post the content 19 on the main display window 11 by selecting the save tab 39. The content 19 is then displayed on the main display window 11.

As discussed above, after the user posts a micro-comment or uploads content 19 such as by selecting the save tab 25, the privacy grid window 30 opens. FIG. 6 illustrates a privacy grid window 30 for controlling the privacy of the content 19 and personas from which the content may be posted in accordance with an embodiment of the present invention. When the user is logging into the system in an unlimited profile access mode, as illustrated in FIG. 3, the privacy grid window 30 allows the user to select which persona to post content 19 from, assign a privacy tier setting to the content 19, and restrict to whom the content 19 may be displayed when a user is logged into the system in a limited profile access mode.

In one embodiment, the privacy grid window 30 contains a series of tabs 35, 36, 37, 38, 39 for customizing privacy setting(s) of the uploaded/posted micro-comments and/or content 19, associating personas with certain micro-comments and/or content 19, and designating privacy levels of certain micro-comments and/or content 19 according to an embodiment of the present invention. In a particular embodiment, the privacy grid window 30 may contain a matrix of privacy tier association tabs 34 for selecting and associating multiple users and/or personas and different privacy tier settings with the uploaded content 19, an advanced privacy customization tab 35 for assigning advanced privacy settings to the content 19, a safe for public tab 36 for expressing and/or assigning no privacy settings to the content 19, a cancel tab 37 for cancelling the privacy customization of the content 19, a back tab 38 for returning to the prior screen, and a post tab 39 for posting the content to the display, to a social network, or any other desired location or service, for example.

In one embodiment, the privacy grid window 30 allows the user to select options to control the privacy of the content 19, such as status text, by specifying which user persona or user is associated with the text (e.g. User 1, User 2, Persona 1, Persona 2, etc.) and/or which privacy tier (e.g. Privacy Tier 1, Privacy Tier 2, etc.) to which the content 19 is published and/or accessible. The personas from which the content 19 is uploaded/posted may be manipulated in the privacy grid window 30. A user may simultaneously select persona and privacy settings for the content 19 in the privacy grid window 30. Upon configuring the persona and privacy settings for the content 19, the post tab 39 uploads/posts the content 19 to the display window 30. Different privacy tiers 33 may be created and configured to correspond with different scopes of privacy and limit access to the uploaded/posted content 19 that is visible to or accessible by a user who logs into the user the user's personal profile with limited access, such as the user's employer. For example, a tier 1 privacy setting may be associated with an unrestricted profile access mode for groups including only the user whereas tier 2, tier 3, tier 4, and tier 5 privacy settings may be associated with a limited profile access mode a certain group of people or things, an extended network of users such as friends, a further extended network of users such as friends, family, and/or acquaintances, or anyone and everything (i.e. the public), respectively.

After the user uploads and assigns privacy settings to content 19, the user then posts the content 19 on the display window 30 by selecting a post tab such as tab 39.

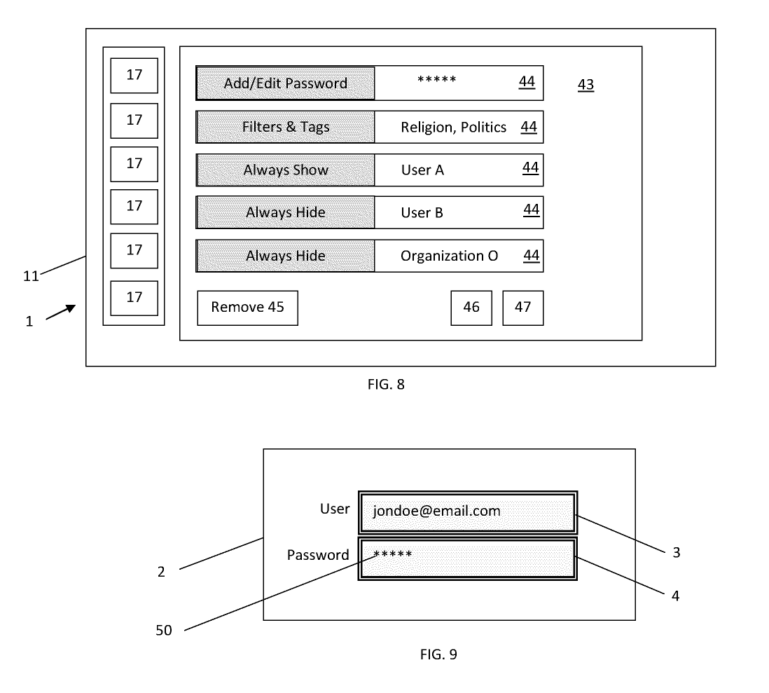

As discussed above, in certain embodiments of the invention, the user may create multiple passwords associated with the user's personal social network profile and assign a different, unique, custom layer of privacy and accessibility settings to each password. FIGS. 7-8 illustrate a password customization interface for creating and editing different passwords (e.g. Password A, Password B, etc.) associated with the user interface, according to an embodiment of the invention. The user may optionally create an unlimited number of passwords associated with one user interface. In one embodiment, the interface 700 has a password customization window 40, which has an add new tab 41 for creating a new password associated with the user interface, and an individual tab 41 and password text box 42 associated with each password which the user creates.

In one embodiment of the present invention, to create a new password or edit an existing password in the user interface, such as an employer password providing limited access to the user's profile, the user, while logged into the interface under a normal, unlimited access mode, selects a settings control tab 17 from the vertical panel 7. This action opens the password customization interface window 40 illustrated in FIG. 7. In such an embodiment, to create a new password, the user selects the add new password tab 41a, which opens the password editing window 43 illustrated in FIG. 8. To edit an existing password, the user may select alternatively the edit password tab 41b that is associated with the password which the user intends to edit, which also opens the password editing window 43 illustrated in FIG. 8.

In one embodiment, the password editing window 43 contains text boxes 44 and one or more tabs 45, 46, 47 for adding or editing information associated with a password or the passwords themselves, as illustrated in FIG. 8. In one example, one text box 44 may be for adding or editing a password. Other text boxes 44 may be used for adding filters for certain content 19 and information (e.g. religious, political), relationships with other users (e.g. User A, User B, etc.), or affiliations with certain groups (e.g. Organization O). A user may add or associate these filters to a certain password in order to out filter this content 19 or information from the user's profile and prevent this content 19 or information from being displayed on the user's profile when a user, such as the user's employer or other third party, for example, accesses the user's profile in a limited access mode using that password. Also, the tabs 45, 46, 47 may include a password removal tab 45 for removing the password, a cancel tab 46 for cancelling edits to passwords, or a save tab 47 for saving the edits to the passwords.

FIG. 9 illustrates a front view of a user login display 2 according to an embodiment of the present invention, as displayed in FIG. 3, however FIG. 9 illustrates the scenario where the user logs into the user interface in a limited profile access mode. For example, FIGS. 3 and 9 illustrate two different passwords associated associate with unlimited and limited profile access modes, respectively. As discussed above, the display 2 contains a user login window 2, text boxes 3, 4 for entering a username 5 and a limited profile access password 50.

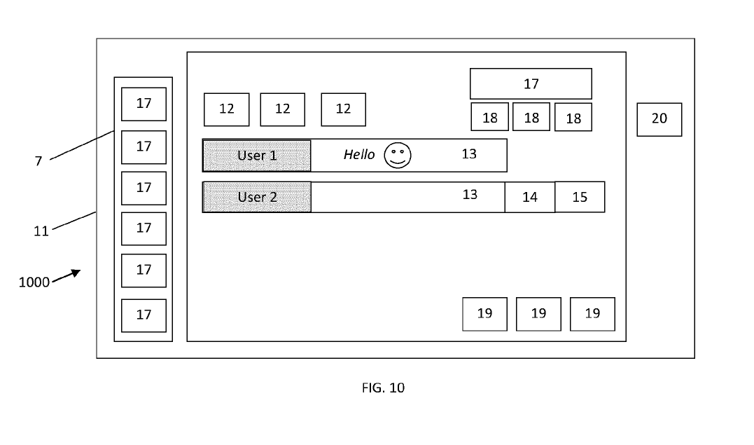

FIG. 10 illustrates a front view of a graphical user interface system 1000 according to an embodiment of the present invention, similar to the embodiment illustrated in FIG. 4, however in a limited access mode. In the limited access mode, certain content 19 is filtered out, not displayed on the window, and therefore invisible to the user whose access is limited. For example, at least a portion of the user consent shown in the exemplary system 400 in FIG. 4 under an unlimited access mode is not visible in the system 1000 shown in FIG. 10 which corresponds to a limited access mode. The system 1000 has a main display window 11, and a vertical panel 7 for displaying or interacting with content 19 from at least one social network or other user content account and customizing user profile settings, as discussed above.

One embodiment of the present invention relates to a computer storage product with a computer-readable medium having computer code thereon for performing various computer-implemented operations according to user interface and interaction methods according to embodiments of the invention. The computer-readable media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media; and hardware devices that are specially configured to store and execute program code, such as application-specific integrated circuits (“ASICs”), programmable logic devices (“PLDs”) and ROM and RAM devices including Flash RAM memory storage cards, sticks and chips, for example. Examples of computer code include machine code, such as produced by a compiler, and files containing higher-level code that are executed by a computer using an interpreter. For example, an embodiment of the invention may be implemented using HTML, XML, JavaScript, Java, C#, C++, Objective C, or other scripting, markup and/or programming languages and development tools. Another embodiment of the invention may be implemented in hardwired circuitry in place of, or in combination with, machine-executable software instructions.

The exemplary embodiments herein described are not intended to be exhaustive or to limit the scope of the invention to the precise forms disclosed. They are chosen and described to explain the principles of the invention and its application and practical use to allow others skilled in the art to comprehend its teachings.

As will be apparent to those skilled in the art in light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A system for controlling access to a user's account, the system comprising:
a graphical user interface for displaying content on the user interface and integrating and manipulating content on the user's account, a display window disposed within the user interface for displaying content from at least one content source associated with the user's account;
a plurality of profile access modes selectable by the user for determining the scope of the user's access to the account, the plurality of profile access modes comprising:
a limited profile access mode for limiting the scope of user's access to the account and the content visible on the account, and
an unlimited profile access mode for providing the user with unlimited access to the account and to the content visible on the account,
an identifier associated with the limited access mode,
wherein when the user attempts to access the account from a source associated with the identifier associated with the limited access mode, the user's account is accessible only through the limited profile access mode.

2. The system of claim 1, wherein the identifier comprises at least one of: a password, an IP address, a geographical location, a virtual location, a type of device and a device identifier.

3. The system of claim 1, wherein the account comprises at least one of: a social network account, an e-mail account, an online service account, a financial service account, or a profile.

4. The system of claim 1, further comprising a privacy grid window within the user interface for selecting one or more privacy tiers and for controlling privacy of the content accessible by the user when logged in under the limited profile access mode.

5. The system of claim 1, wherein the identifier is at least one of: predetermined or customizable by the user.

6. The system of claim 1, wherein the identifiers is at least one of: automatically or manually predetermined by the user.

7. The system of claim 1, further comprising a plurality of limited profile access modes and associated indentifiers, wherein each limited profile access mode may be individually configured by a user to limit the scope of user access to the account and the content visible on the account in associate with each limited profile access mode.

8. The system of claim 1, further comprising
a semi-limited profile access mode for limiting the scope of user's access to the account,
an identifier associated with the semi-limited access mode, and
wherein when the user attempts to access the account from a source associated with the identifier associated with the semi-limited access mode, the user's account is accessible only through the semi-limited profile access mode, and
wherein the scope of the user's access in the limited profile mode is less than the scope of the user's access in the semi-limited access mode, and the scope of the user's access in the semi-limited profile access mode is less than the scope of the user's access in the unlimited profile access mode.

9. A system for controlling access to a user's account, the system comprising:
a graphical user interface for displaying content associated with the user's account,
a display window disposed within the user interface for displaying content from a content source,
a plurality of profile access modes for determining the scope of the user's access to the account, and
an identifier associated with each access mode,
wherein when the user attempts to access the account from a source associated with the identifier, the user's account is accessible only through the associated one of the access modes.

10. The system of claim 9, wherein the identifier comprises at least one of: a password, an IP address, a geographical location, a virtual location, a type of device and a device identifier.

11. The system of claim 9, wherein the account comprises at least one of: a social network account, an e-mail account, an online service account, a financial service account, or a profile.

12. The system of claim 9, further comprising a privacy grid window within the user interface for selecting one or more privacy tiers and for controlling privacy of the content accessible by the user when logged in under each of the plurality of profile access modes.

13. The system of claim 9, wherein the identifier is at least one of: predetermined or customizable by the user.

14. The system of claim 9, wherein the identifiers is at least one of: automatically or manually predetermined by the user.

15. A method for controlling access to a user's account, the method comprising:
providing a system for controlling access to user's account, the system comprising a graphical user interface for displaying content on the user interface, a display window disposed within the user interface for displaying content from at least one content source associated with the user's account;
a plurality of profile access modes selectable by the user for determining the scope of the user's access to the account, the plurality of profile access modes comprising:
a limited profile access mode for limiting the scope of user's access to the account and the content visible on the account, and
an unlimited profile access mode for providing the user with unlimited access to the account and to the content visible on the account, an identifier associated with the limited access mode;
receiving an identifier from the user for accessing the user's account;
accessing the user's account only through the limited profile access mode if the identifier is associated with the limited profile access mode, else accessing the user's account through the unlimited profile access mode.

16. The method of claim 15, wherein the identifier comprises at least one of: a password, an IP address, a geographical location, a virtual location, a type of device and a device identifier.

17. The method of claim 15, wherein the account comprises at least one of: a social network account, an e-mail account, an online service account, a financial service account, or a profile.

18. The method of claim 15, further comprising a privacy grid window within the user interface for selecting one or more privacy tiers and for controlling privacy of the content accessible by the user when logged in under the limited profile access mode.

19. The method of claim 15, wherein the identifier is at least one of: predetermined, customizable by the user, automatically predetermined and manually predetermined by the user.

20. The method of claim 15, further comprising a plurality of limited profile access modes and associated identifiers, wherein each limited profile access mode may be individually configured by a user to limit the scope of user access to the account and the content visible on the account in association with each limited profile access mode.
